(19) United States
(12) Patent Application Publication
(10) Pub. No.: US 2012/0221242 A1
(43) Pub. Date: Aug. 30, 2012

(54) NAVIGATION DEVICE AND A METHOD OF OPERATION OF A NAVIGATION DEVICE

(76) Inventors: Hans Schulte, Best (NL); Rob Seggelen, Budel (NL)

(21) Appl. No.: 13/388,724

(22) PCT Filed: Aug. 3, 2009
(86) PCT No.: PCT/EP2009/060043

§ 371 Date: May 16, 2012

(51) Int. Cl. G01C 21/00

(52) U.S. Cl. 701/468; 701/408

(57) ABSTRACT

A navigation device comprising a processing module (410); at least one conditional trigger (420); and, a data store (430) for storing at least one trigger condition; the processing module being adapted to compare the status of the at least one conditional trigger to the at least one trigger condition stored in the data store to determine if there is a match and to perform a predetermined navigation process if a match is found.

### FIELD OF THE INVENTION

The present invention relates to a navigation device. More particularly, but not exclusively, the present invention relates to a navigation device comprising a processing module which compares the status of at least one conditional trigger to at least one trigger condition and performs a predetermined navigation process if a match is found. The present invention also relates to a method of operation of a navigation device. More particularly, but not exclusively, the present invention relates to a method of operation of a navigation device comprising the steps of comparing the status of at least one conditional trigger to at least one stored trigger condition and performing a navigation process if a match is found.

### BACKGROUND TO THE INVENTION

Portable navigation devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

To set a navigation destination a user typically has to press several buttons, for example tying in the destination address, setting the zoom level etc. Due to this need to press several buttons operation of a navigation device in an in-car environment often leads to distraction and unsafe driving.

The present invention seeks to overcome the problems of the prior art.

### SUMMARY OF THE INVENTION

In a first aspect the present invention provides a navigation device comprising
a processing module;
at least one conditional trigger; and,
a data store for storing at least one trigger condition;
the processor module being adapted to compare the status of the at least one conditional trigger to the at least one trigger condition stored in the data store to determine if there is a match and to perform a predetermined navigation process if a match is found.

The navigation device according to the invention can adjust its own settings when predetermined trigger conditions are met with only minimal, if any, user interaction. The device is simpler to use than known navigation devices eliminating much of the repetitive inputting of data. It is also safer to use in an in-car environment as the user is not distracted by the need to input data.

Preferably, the navigation device comprises a plurality of conditional triggers.

Preferably, the conditional trigger comprises at least one of a device for determining the position of the navigation device or a device for determining the time at the navigation device.

At least one conditional trigger can comprise a GPS system.

At least one conditional trigger can comprise a clock or a receiver for receiving a clock signal.

The at least one trigger condition can comprise at least one of a stored time or time range or a stored position or stored area.

Preferably, the processing module determines a match based on at least one of the proximity of the navigation device to a stored position or area or the proximity of the determined time to the stored time or time range.

Preferably, the navigation process alters a state of the navigation device, preferably alters the stored final destination of the device.

In a further aspect of the invention there is provided a method of operation of a navigation device comprising the steps of
providing a navigation device, the navigation device comprising a processing module, at least one conditional trigger and a data store for storing at least one trigger condition;
comparing the status of the at least one conditional trigger to the at least one stored trigger condition to determine if a match is found; and,
the processing module performing a predetermined navigation process in response to a found match.

Preferably, the navigation process alters a state of the navigation device, preferably alters the stored final destination of the device.

The conditional trigger can comprise at least one of a device for determining the position of the navigation device or a device for determining the time at the navigation device

The at least one conditional trigger can comprise a GPS system

The at least one conditional trigger can comprise a clock or a receiver for receiving a clock signal

Preferably, the at least one trigger condition comprises at least one of a stored time or time range or a stored position or stored area.

Preferably, the determination of a match is based on at least one of the proximity of the navigation device to a stored position or area or the proximity of the determined time to the stored time or time range.

In a further aspect of the invention there is provided computer software comprising one or more software modules operable when executed in an execution environment of a navigation device to cause a processing module to
determine the status of at least one conditional trigger;
compare the determined status to at least one stored trigger condition to determine if a match is found; and,
if a match is found perform a navigation process.

Preferably, the navigation process alters a state of the navigation device, preferably alters a final destination stored in the navigation device.

### BRIEF DESCRIPTION OF THE DRAWINGS

The present invention will now be described by way of example only, and not in any limitative sense with reference to the accompanying drawings in which

FIG. 1 shows, in schematic form, a Global Positioning System (GPS);

FIG. 2 shows, in schematic form a known portable navigation device (PND);

FIG. 3 shows, in schematic form, the manner in which a further portable navigation device may receive information over a wireless communication channel; and,

FIG. 4 shows, in schematic form, a navigation device according to the invention;

### DETAILED DESCRIPTION OF PREFERRED EMBODIMENTS

Preferred embodiments of the present invention will now be described with particular reference to a PND. It should be remembered, however, that the teachings of the present invention are not limited to the PNDs described but are instead universally applicable to any type of PND that is configured to execute navigation software so as to provide route planning and navigation functionality. It follows therefore that in the context of the present application, a portable navigation device is intended to include (without limitation) a portable personal computer (PC), mobile telephone or portable digital assistant (PDA)) executing route planning and navigation software.

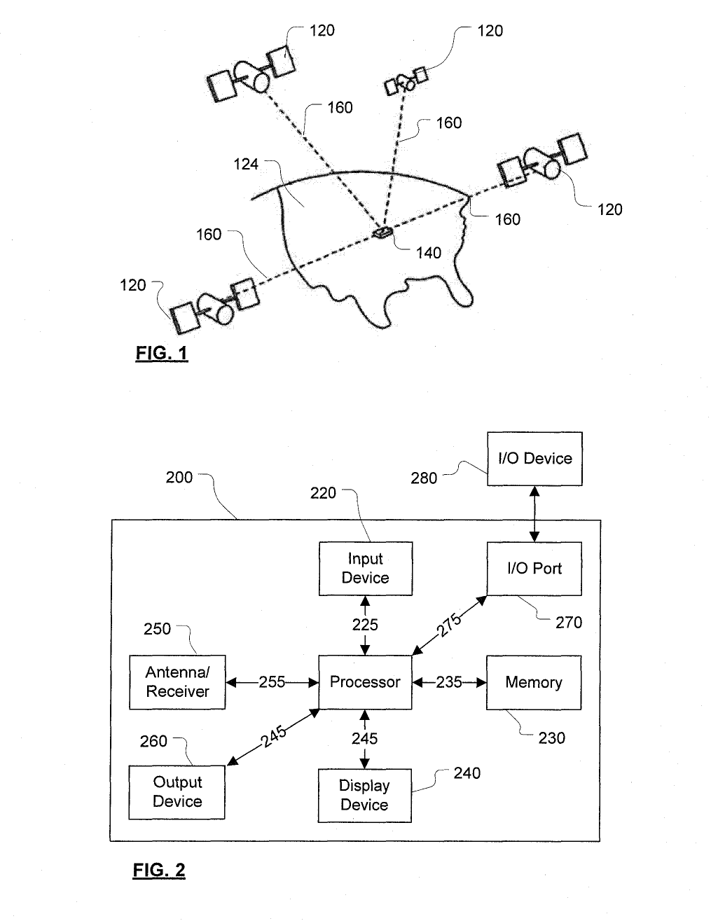

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

FIG. 2 is an illustrative representation of electronic components of a known portable navigation device 200 in block component format. It should be noted that the block diagram of the portable navigation device 200 is not inclusive of all components of the portable navigation device, but is only representative of many example components.

The portable navigation device 200 comprises a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In a particularly preferred arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The portable navigation device may include an output device 260, for example an audible output device (e.g. a loudspeaker). As output device 260 can produce audible information for a user of the portable navigation device 200, it is should equally be understood that input device 240 can include a microphone and software for receiving input voice commands as well.

In the portable navigation device 200, processor 210 is operatively connected to and set to receive input information from input device 220 via a connection 225, and operatively connected to at least one of display screen 240 and output device 260, via output connections 245, to output information thereto. Further, the processor 210 is operably coupled to a memory resource 230 via connection 235 and is further adapted to receive/send information from/to input/output (I/O) ports 270 via connection 275, wherein the I/O port 270 is connectible to an I/O device 280 external to the navigation device 200. The memory resource 230 comprises, for example, a volatile memory, such as a Random Access Memory (RAM) and a non-volatile memory, for example a digital memory, such as a flash memory. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the portable navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are possible. For example, the components shown in FIG. 2 may be in communication with one another via wired and/or wireless connections and the like.

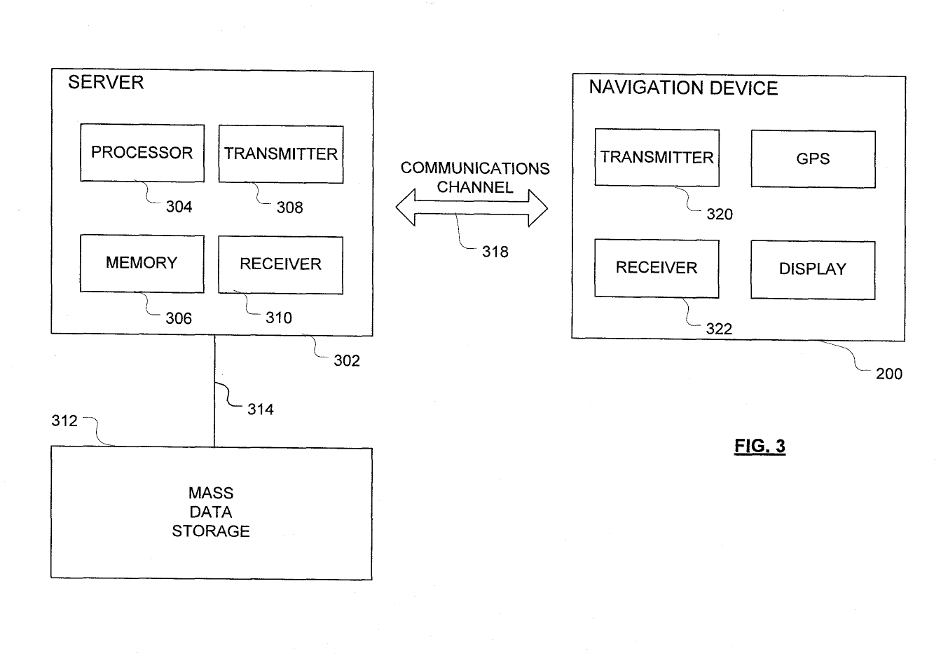

Referring now to FIG. 3, the portable navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the portable navigation device 200 and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The portable navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The portable navigation device 200 may include its own mobile phone technology within the portable navigation device 200 itself (including an antenna for example, or optionally using the internal antenna of the portable navigation device 200). The mobile phone technology within the portable navigation device 200 can include internal components as specified above, and/or can include an insertable card (e.g. Subscriber Identity Module or SIM card), complete with necessary mobile phone technology and/or an antenna for example. As such, mobile phone technology within the portable navigation device 200 can similarly establish a network connection between the portable navigation device 200 and the server 302, via the internet for example, in a manner similar to that of any mobile device.

For GRPS phone settings, a Bluetooth enabled portable navigation device may be used to correctly work with the ever changing spectrum of mobile phone models, manufacturers, etc., model/manufacturer specific settings may be stored on the portable navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a portable navigation device 200 can communicate when a connection via communications channel 318 is established between the server 302 and the portable navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from portable navigation device 200 via communications channel 318. The signals sent and received may include data, communication, and/or other propagated signals. The transmitter 308 and receiver 310 may be selected or designed according to the communications requirement and communication technology used in the communication design for the portable navigation device 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The portable navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the portable navigation device 200 and the functions of the transmitter 320 and receiver 322 may be combined into a single transceiver.

Software stored in server memory 306 provides instructions for the processor 304 and allows the server 302 to provide services to the portable navigation device 200. One service provided by the server 302 involves processing requests from the portable navigation device 200 and transmitting navigation data from the mass data storage 312 to the portable navigation device 200. Another service provided by the server 302 includes processing the navigation data using various algorithms for a desired application and sending the results of these calculations to the portable navigation device 200.

The communication channel 318 generically represents the propagating medium or path that connects the portable navigation device 200 and the server 302. Both the server 302 and portable navigation device 200 include a transmitter for transmitting data through the communication channel and a receiver for receiving data that has been transmitted through the communication channel.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the portable navigation device 200. Alternatively, a personal computer may be connected between the portable navigation device 200 and the server 302 to establish an internet connection between the server 302 and the portable navigation device 200. Alternatively, a mobile telephone or other handheld device may establish a wireless connection to the internet, for connecting the portable navigation device 200 to the server 302 via the internet.

The portable navigation device 200 may be provided with information from the server 302 via information downloads which may be periodically updated automatically or upon a user connecting portable navigation device 200 to the server 302 and/or may be more dynamic upon a more constant or frequent connection being made between the server 302 and portable navigation device 200 via a wireless mobile connection device and TCP/IP connection for example. For many dynamic calculations, the processor 304 in the server 302 may be used to handle the bulk of the processing needs, however, processor 210 of portable navigation device 200 can also handle much processing and calculation, oftentimes independent of a connection to a server 302.

As indicated above in FIG. 2, a portable navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the portable navigation device 200 can also include any additional input device 220 and/or any additional output device 241, such as audio input/output devices for example.

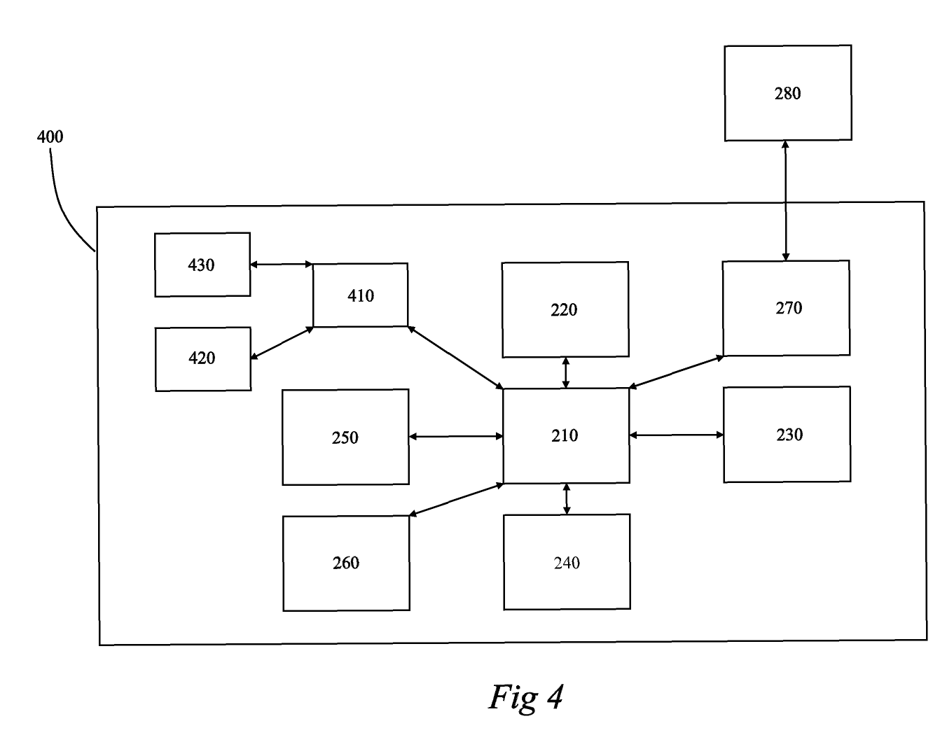

Shown in FIG. 4 is a navigation device 400 according to the invention shown in schematic form. The navigation device 400 is similar to that of FIG. 2 and like parts are referenced by like reference numerals. The navigation device 400 according to the invention comprises a processing module 410. Connected to the processing module 410 is a conditional trigger 420 and a data store 430.

In this embodiment the conditional trigger 420 comprises means for determining time at the navigation device. In this embodiment the control trigger 420 is a receiver for receiving a clock signal. The data store 430 stores at least one trigger condition which in this embodiment is a time or time range. In use the processing module 410 compares the determined time provided by the conditional trigger 420 with the at least one time or time range stored in the data store 430 as a trigger condition. If the determined time is within the stored time range or sufficiently close to a stored time then the processing module 410 considers there to be a match and performs a navigation process.

The navigation process sets the state of the navigation device 400. In this embodiment the navigation process running on the processing module 410 instructs the processor 210 of the navigation device 400 to set the final navigation destination to a pre-stored destination. In an alternative embodiment the processing module 410 directly changes the state of the final navigation destination for example by changing the content of the relevant portion of the shared memory shared with the processor 210.

As an example, if the navigation device 400 is switched on around the time the user typically finishes work the processing module 410 will match the determined time with the ‘finishing work’ time range stored in the data store 430. The processing module 410 runs a navigation process in response to this match, instructing the processor 210 of the navigation device 400 to set the final destination to be the users home. The data store 430 could store a number of different trigger conditions, being different times or time ranges. Each of these could have different associated navigation processes. As an example, the data store 430 could include a ‘morning’ time range and an ‘evening’ time range. If the navigation device 400 is switched on during the morning time range the match results in a navigation process executing which sets the final destination as the users place of work. If the navigation device 400 is switched on during the evening time range then the match results in a different navigation process running and the final destination being set as the users home. The navigation device 400 may also be able to distinguish between the days of the week and the weekend. It may perform one navigation process during the week (for example set the final destination to users place of work) and a different action, or no action, at the weekend.

In the above examples the navigation processes instructs the processing module 410 to either directly or indirectly set the final destination for the navigation device 400. In alternative embodiments the navigation processes may take other actions such as setting the scale of the display, setting the display mode (for example day/night) switching the speaker on or off etc.

In the above embodiment the navigation processes and associated times or time ranges are set by the user via the input/output device 280. Typically this is done by a touch screen although other alternatives are possible, such as connecting the navigation device 400 to a computer (not shown) running suitable software. In an alternative embodiment the times and/or time ranges are set during manufacture as an alternative or in addition to those set by the user. For example, if the navigation device 400 is on after dark the processing module 410 will match this to a pre-stored time range included during manufacture and run a navigation process which switches the display 240 to a night display.

In the above embodiment the processing module 410 is separate from the processor 210. This could be useful if for example the processing module 410, conditional trigger 420 and data store 430 are optional extras which can be plugged into the navigation device 400. The extra functionality provided by these components can be purchased after purchasing the original navigation device 400. The extra components can be activated/deactivated by a switch (not shown). Alternatively they can be activated or deactivated by a control panel of the navigation device 400.

In an alternative embodiment of the invention the processing module 410 and processor 210 are the same component. For a portion of its time the processor 210 acts as a processing module 410 comparing the state of the conditional trigger 420 to the trigger conditions in the data store 430. For the remainder of its time the processor 210 manages the navigation device 400. If a match is found the processor 210 performs the navigation process. The process may instruct the processor 210 to change the state of the navigation device 400. Alternatively, it may change the state of the navigation device 400 directly. Such techniques are well known in this field.

In an alternative embodiment of the invention (not shown) the conditional trigger 420 comprises a device for determining the position of the navigation device, preferably a GPS system. The GPS system may be an additional component connected to the processing means 410, separate from the GPS system used by the processor 210.

Alternatively, the GPS system of the navigation device 400 may be shared by both the processor 210 and processing module 410. This is particularly suitable where a single processor 210 acts both as a processor 210 for managing the navigation device 400 and as a processing module 410. In this embodiment the data store 430 may store one or more positions or areas. In use if the navigation device 400 travels within a pre-stored area or sufficiently close to a pre-stored position the processing module 410 considers there to be a match and performs the associated navigation process.

In a further alternative embodiment the navigation device 400 can include more than one conditional trigger 420. For example it may include both a clock and a GPS system. The trigger conditions stored within the data store 430 may relate to both conditional triggers 420. For example there may only be a match if the navigation device 400 is used both within a particular area and within a particular time range. As an example a navigation process may be performed if a user leaves work at a normal time being within both the required geographical area and time limits. When the user is on holiday however the navigation process will not be executed as the navigation device 400 will not be within the stored area.

From the point of view of the user the method and device according to the invention has a number of advantages. Firstly, there is a significant increase in ease of use. The navigation device 400 will often be able to correctly set the destination without any input from the user based (for example) on only the time of day and location of the navigation device 400. There is also an increase in safety. If the navigation device 400 correctly sets the destination without user input there is a reduced temptation for a user to program the navigation device 400 whilst the vehicle is in motion. Further, there is an increased perception of user satisfaction with the navigation device 400. The navigation device 400 can often anticipate the users wishes, switching to a night mode late at night, avoiding busy routes during the rush hour etc, all based on trigger conditions.

In a further embodiment of the invention, the navigation device 400 may learn the habits of the user, expressing these as trigger conditions stored within the data store 430.

In alternative embodiments other conditional triggers 420 are possible. A further conditional trigger could comprise a thermometer which measures the temperature outside the vehicle. The trigger could also be a rain sensor and/or a real time information source for example from the internet. As an example the processor module may detect that the temperature has dropped below zero Celsius and may offer the driver a safer route avoiding steep hills or mountainous areas. In a further alternative embodiment the processor module may offer a different route if bad weather is predicted from a real time data source.

In a further embodiment of the invention the navigation device can be programmed with trigger conditions. For example if the navigation device is connected to a wireless network it can receive new trigger conditions provided remotely, for example by the manufacturer.

1. A navigation device comprising:
a processing module;
at least one conditional trigger arranged to determine at least one of the position of the navigation device and the time at the navigation device; and,
a data store for storing at least one trigger condition, wherein the stored trigger condition comprises at least one of a spatial or temporal parameter derived from historical use of the navigation device;
the processor module being adapted to compare the status of the at least one conditional trigger to the at least one trigger condition stored in the data store to determine if there is a match and to perform a predetermined navigation process if a match is found;
wherein the predetermined navigation process comprises setting a pre-stored location as a navigation destination.

2. A navigation device as claimed in claim 1, comprising a plurality of conditional triggers.

3. (canceled)

4. A navigation device as claimed in claim 1, wherein the at least one conditional trigger comprises a GPS system.

5. A navigation device as claimed in claim 1, wherein the at least one conditional trigger comprises a clock or a receiver for receiving a clock signal.

6. A navigation device as claimed in claim 1, wherein the at least one trigger condition comprises at least one of: (i) a stored time or time range; and (ii) a stored position or stored area.

7. A navigation device as claimed in claim 6, wherein the processing module determines a match based on at least one of the proximity of the navigation device to a stored position or area or the proximity of the determined time to a stored time or time range.

8. (canceled)

9. A method of operation of a navigation device comprising:
providing a navigation device, the navigation device comprising:
a processing module,
at least one conditional trigger arranged to determine at least one of the position of the navigation device and the time at the navigation device, and
a data store for storing at least one trigger condition, wherein the stored trigger condition comprises at least one of a spatial or temporal parameter derived from historical use of the navigation device;
comparing the status of the at least one conditional trigger to the at least one stored trigger condition to determine if a match is found; and,
the processing module performing a predetermined navigation process in response to a found match, wherein the predetermined navigation process comprises setting a pre-stored location as a navigation destination.

10. (canceled)

11. (canceled)

12. A method as claimed in claim 9, wherein the at least one conditional trigger comprises a GPS system.

13. A method as claimed in claim 9, wherein the at least one conditional trigger comprises a clock or a receiver for receiving a clock signal.

14. A method as claimed in claim 9, wherein the at least one trigger condition comprises at least one of: (i) a stored time or time range; and (ii) a stored position or stored area.

15. A method as claimed in claim 14, wherein the determination of a match is based on at least one of the proximity of the navigation device to a stored position or area or the proximity of the determined time to a stored time or time range.

16. Computer software comprising one or more software modules operable when executed in an execution environment of a navigation device to cause a processing module to:
determine the status of at least one conditional trigger of the navigation device, the at least one conditional trigger being arranged to determine at least one of the position of the navigation device and the time at the navigation device;
compare the determined status to at least one stored trigger condition to determine if a match is found, wherein the stored trigger condition comprises at least one of a spatial or temporal parameter derived from historical use of the navigation device; and,
if a match is found, perform a predetermined navigation process, wherein the predetermined navigation process comprises setting a re-stored location as a navigation destination.

17. (canceled)

18. A navigation device comprising:
a processing module;
at least one conditional trigger arranged to determine the position of the navigation device and the time at the navigation device; and,
a data store for storing trigger conditions, wherein the stored trigger conditions comprise a time range and position, and are derived from historical use of the navigation device;
the processor module being adapted to compare the status of the at least one conditional trigger to the at least one trigger condition stored in the data store to determine if there is a match and to perform a predetermined navigation process if a match is found;
wherein the processing module determines a match when the navigation device is determined by the at least one conditional trigger to be within the stored time range and sufficiently close to the stored position; and
wherein the predetermined navigation process comprises setting a pre-stored location associated with the plurality of trigger conditions as a navigation destination.
